(19) United States
(12) Patent Application Publication
(10) Pub. No.: US 2013/0204945 A1
(43) Pub. Date: Aug. 8, 2013

(54) METHOD AND APPARATUS FOR TRANSMITTING DATA

(71) Applicant: Huawei Technologies Co., Ltd., Shenzhen (CN)

(72) Inventors: Dongyuan Li, Shenzhen (CN); Fenglong Jin, Shenzhen (CN)

(73) Assignee: Huawei Technologies Co., Ltd., Shenzhen (CN)

(21) Appl. No.: 13/720,482

(22) Filed: Dec. 19, 2012

Related U.S. Application Data
(63) Continuation of application No. PCT/CN2012/070900, filed on Feb. 6, 2012.

(51) Int. Cl. H04L 29/08

(52) U.S. Cl. CPC H04L 67/104
USPC 709/205

(57) ABSTRACT

A method for transmitting data, which relates to the field of communication technologies includes displaying an icon representative of a peer device as a first state when failing to connect the peer device. A data transmission event is detecting between a local device and the peer device. A data transmission task corresponding to the detected data transmission event is created. When the local device is connected with the peer device successfully, the method includes executing the data transmission task, and displaying the icon as a second state.

### CROSS-REFERENCE TO RELATED APPLICATIONS

This application is a continuation of International Application No. PCT/CN2012/070900, filed on Feb. 6, 2012, which is hereby incorporated by reference in its entirety.

### FIELD OF THE APPLICATION

The present application relates to the field of communication technologies, and in particular, to a method and apparatus for transmitting data.

### BACKGROUND OF THE APPLICATION

Currently, mobile terminals and tablet computers provide high-performance processing and lower-layer communication interfaces and can communicate with computers, set top boxes, and so on. People may perform operations such as copying and sharing pictures between such devices. However, a connection, including a wired connection or wireless connection, needs to be created before communication begins between the devices, and the operations such as transmission can be performed after a peer device is found.

The existing communication device generally requires manual connection to the peer device. For example, the user operates on a mobile phone to create a connection with a notebook computer. However, for various reasons, the peer device usually cannot be connected in real time. In this case, the device stops processing for the moment and does not support further operation, but gives a prompt to the user indicating that no peer device is found or that the attempt of connecting the peer device fails, and so on. The user cannot perform the subsequent transmission or sharing until the peer device is connected. Consequently, the inconvenience is brought to the user operation. Moreover, reattempt of creating a connection requires the user to wait and resume operations; or, due to change of the user environment, the user forgets which files need to be transmitted when intending to create the connection again after a period of time, and so on, which greatly affect the user experience.

### SUMMARY OF THE APPLICATION

To solve the problems in the conventional art, embodiments provide a method and apparatus for transmitting data. The technical solutions are as follows:

A method for transmitting data includes:

displaying an icon representative of a peer device as a first state when failing to connect the peer device;

detecting a data transmission event between a local device and the peer device;

creating a data transmission task corresponding to the detected data transmission event; and

when the local device is connected with the peer device successfully, executing the data transmission task, and displaying the icon representative of the peer device as a second state.

Further, an apparatus for transmitting data includes:

a display module, configured to display an icon representative of a peer device as a first state when failing to connect the peer device, and display the icon as a second state when the apparatus is connected with the peer device successfully;

a detecting module, configured to detect a data transmission event between the apparatus and the peer device;

a creating module, configured to create a data transmission task corresponding to the data transmission event detected by the detecting module; and

a transmission module, configured to execute the data transmission task created by the creating module when the apparatus is connected with the peer device successfully.

The benefits brought by the technical solution are: the data transmission event between the local device and the peer device is detected, the corresponding data transmission task is created, and the data transmission task is executed after the peer device is connected successfully. In this way, the unconnected device is operated, and the data is transmitted automatically after the device is connected successfully. The user does not have to wait for connecting, the interactive operations for data transmission in a complicated environment are simplified, the user is facilitated significantly, the user experience is enhanced, and the user is more interested in sharing and more attached to the product.

### BRIEF DESCRIPTION OF THE DRAWINGS

To illustrate the technical solutions in the embodiments, the following briefly describes the accompanying drawings required for describing the embodiments. Apparently, the accompanying drawings in the following description illustrate merely show some embodiments, and persons of ordinary skill in the art can derive other accompanying drawings from these accompanying drawings without creative efforts.

FIG. 1 is a flowchart of a method for transmitting data according to an embodiment;

FIG. 2 is a schematic diagram of different display states of an icon of a peer device according to an embodiment;

FIG. 3 is another flowchart of a method for transmitting data according to an embodiment;

FIG. 4 is a schematic diagram of displaying number of pieces of data to be transmitted according to an embodiment;

FIG. 5 is still another flowchart of a method for transmitting data according to an embodiment;

FIG. 6 is yet another flowchart of a method for transmitting data according to an embodiment;

FIG. 7 is a schematic diagram of an interface for playing a media file according to an embodiment;

FIG. 8 is a schematic diagram of an interface for displaying an electronic document according to an embodiment;

FIG. 9 is a schematic diagram of displaying a list of data to be transmitted according to an embodiment;

FIG. 10 is a schematic diagram of displaying a local device and a peer device according to an embodiment;

FIG. 11 is a schematic structural diagram of an apparatus for transmitting data according to an embodiment; and

FIG. 12 is a schematic diagram of a hardware structure of a local device according to an embodiment.

### DETAILED DESCRIPTION OF THE EMBODIMENTS

To make the objectives, technical solutions, and advantages more comprehensible, the following describes in further detail with reference to the accompanying drawings.

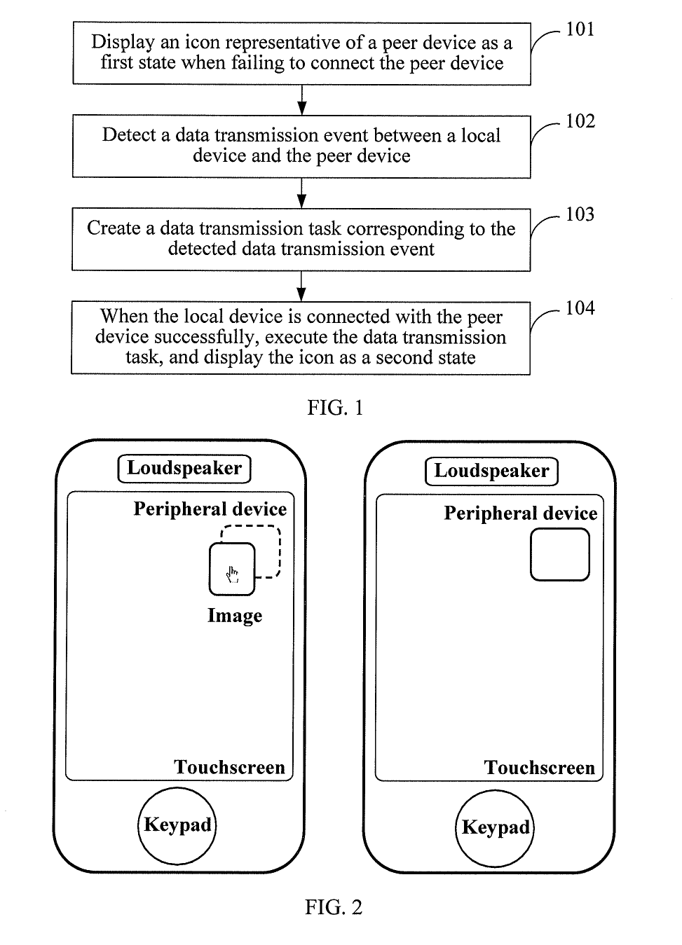

As shown in FIG. 1, a method for transmitting data is provided in an embodiment. The method includes the following steps:

101: Display an icon representative of a peer device as a first state when failing to connect the peer device.

In this step, the entity for detecting failure of connecting the peer device is the local device. A wired connection or wireless connection may be created between the local device and the peer device. The two devices communicate with each other. That is, they are two data devices for implementing communication or data exchange. For ease of description, devices that participate in the communication or data exchange are herein called a local device and a peer device. The peer device is also known as a peripheral device of the local device, and is a device at a certain distance from the local device, and is generally a short-distance device. Either the local device or the peer device may be a terminal, including a wired terminal, such as a computer and a set top box; or a wireless terminal, such as a mobile phone, a notebook computer and a tablet computer, which is not limited herein. The wired connection includes but is not limited to: USB (Universal Serial Bus, universal serial bus) connection, network cable connection, video cable connection, and so on; the wireless connection includes but is not limited to: Bluetooth connection, infrared connection, wifi connection, and so on, which is not limited herein. When the local device initiates data transmission, data exchange or data communication, the local device needs to know whether the peer device is in the working state, or whether the communication link between the local device and the peer device is smooth. If the peer device is in the non-working state, or the communication link between the local device and the peer device is baffled or faulty, the local device presents the unavailable state of the peer device to the user of the local device, namely, displays the icon representative of the peer device as a first state.

102: Detect a data transmission event between the local device and the peer device.

Detecting the data transmission event between the local device and the peer device may be: detecting the data transmission event to be started, namely, a data transmission event triggered by an output transmission request sent by the local device to the peer device through a data transmission instruction sent by the user, or may be a transmission event about underway data transmission, such as data transmission interruption caused by a network fault, or data transmission interruption caused by moving the local device out of the link scope of the peer device. Especially, when the transmission event is a data transmission event triggered by the user and to be started, the creation of the data transmission event may be: the event of dragging the data to the icon, and determining that the user initiates a request for transmitting the data to the peer device. Specifically, when the attempt of connecting the peer device fails, the user needs to make pre-transmission preparation on the local device for certain reasons. When the connection between the local device and the peer device is available, the content of the pre-transmission preparation may be transmitted to the peer device in time. As a means of implementing the foregoing process, the user may operate the icon representative of the data content to be transmitted on the local device directly, for example, drag the icon of the icon representative of data to be transmitted to the position of the icon representative of the peer device. The drag process may be implemented through mouse clicking and dragging, or through touch control on the touch screen, which is not limited herein. Besides, the data transmission event in various scenarios may be: transmitting opened data, or transmitting unopened data. The opened data includes but is not limited to: a media file being played, or an electronic document being read, and so on.

103: Create a data transmission task corresponding to the detected data transmission event.

Create the corresponding data transmission task according to the detected data transmission event. The data transmission task is not executed when the connection between the local device and the peer device fails; however, the data transmission task makes preparation for the data transmission to be performed when the connection between the local device and the peer device recovers or succeeds. The preparation includes: recording the address or content of the data to be transmitted in the data transmission task, or a start point of the data transmission task. This scenario is directed to a circumstance that underway data transmission is interrupted between the local device and the peer device. Or, the preparation includes: recording the address or content of the data as a data transmission task if the data transmission event is to transmit unopened data; or, recording the address or content of the data and the current play location or page location of the data and using all recorded contents as the data transmission task if the data transmission event is to transmit opened data.

104: When the local device is connected with the peer device successfully, execute the data transmission task, and display the icon representative of the peer device as a second state. The procedure is ended.

In the embodiment, the first state is different from the second state, and the first state represents failure of connecting the peer device, and the second state represents success of connecting the peer device. Preferably, the boundary of the icon is displayed by a dotted line to indicate the first state, and the boundary of the icon is displayed by a solid line to indicate the second state; or, the icon is displayed in a specified gray scale to indicate the first state, and the icon is displayed normally to indicate the second state; nevertheless, the states may be indicated by other means, which are not limited herein. For example, as shown in FIG. 2, the local device has a peripheral device: device 1. The icon of device 1 is displayed on the screen. The current device 1 is in a connection failure state. Therefore, the icon is displayed through a dotted line boundary, as shown in the left-side diagram in FIG. 2. After a period, device 1 is connected successfully, and the icon is displayed through a solid line boundary, as shown in the right-side diagram in FIG. 2.

In this embodiment, the data in the data transmission event may be data of any format, including but not limited to: picture, file, electronic document, media file, and so on, where the media file may be a media file being played, the electronic document may be an electronic document being read, which is not limited herein.

In the method provided in this embodiment, the data transmission event between the local device and the peer device is detected, the corresponding data transmission task is created, and the data transmission task is executed after the peer device is connected successfully. In this way, the unconnected device is operated, and the data is transmitted automatically after the device is connected successfully. The user does not have to wait for connecting, the interactive operations for data transmission in a complicated environment are simplified, the user is facilitated significantly, the user experience is enhanced, and the user is more interested in sharing and more attached to the product.

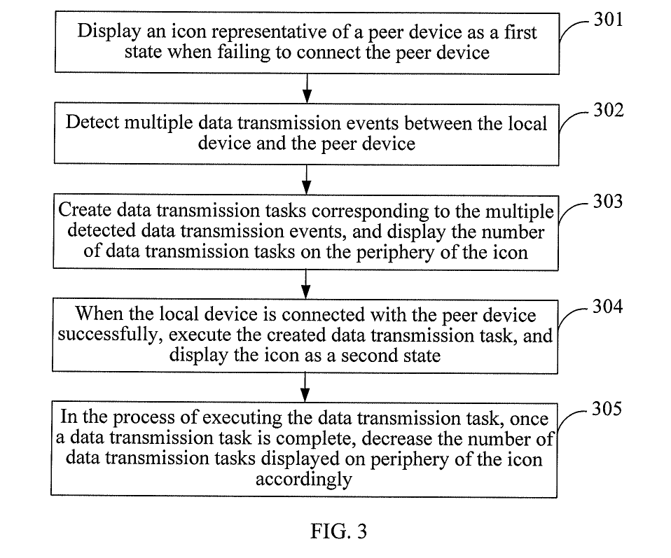

As shown in FIG. 3, a method for transmitting data is provided in another embodiment. The method includes the following steps:

301: Display an icon representative of a peer device as a first state when failing to connect the peer device.

302: Detect multiple data transmission events between the local device and the peer device.

This step may include: detecting whether an event of moving data to the icon occurs on the local device; and, if so, determining that the local device initiates a data transmission event of transmitting the data to the peer device.

303: Create data transmission tasks corresponding to the multiple detected data transmission events, and display the number of data transmission tasks on the periphery of the icon.

Generally, each data transmission event corresponds to a data transmission task. That is, the number of data transmission events is equal to the number of data transmission tasks.

304: When the local device is connected with the peer device successfully, execute the created data transmission tasks, and display the icon representative of the peer device as a second state. The procedure is ended.

Further, the method may include:

305: In the process of executing the data transmission tasks, the number of data transmission tasks displayed on the periphery of the icon decreases accordingly after each data transmission task is complete, thereby facilitating the user to understand the change of the number of data transmission tasks in time. The specific mode of decreasing the number accordingly is not limited herein. For example, the number may decrease by 1, and so on.

The first state is different from the second state so that it is identifiable whether the peer device is currently in a connectible state. More details may be obtained with reference to the description in the preceding embodiment, and are not repeated herein.

In this embodiment, the periphery of the icon is preferably the edge of the icon, and the edge may be the edge in any direction of the icon. For example, when the icon is a square, the edge may be any place of the square that displays the number of pieces of data to be transmitted, such as the upper right corner, upper left corner, lower left corner, or lower right corner of the square. The area occupied by the displayed number in the screen may partly overlap the icon, or fully overlap the icon, or never overlap the icon, which is not limited herein.

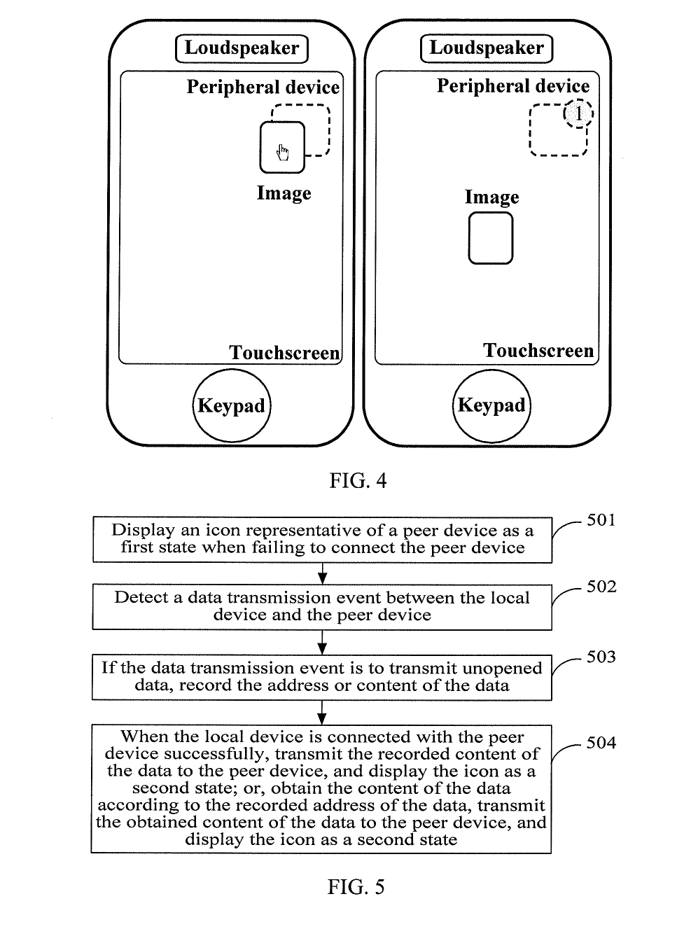

For example, as shown in FIG. 4, the local device has a peripheral device, which may be called a peer device and is currently not connectible. The icon representative of the peer device is displayed through a dotted line boundary. If it is detected that the user drags a picture to be transmitted onto the icon, it is determined that the user initiates a request for transmitting the picture to the peer device. Therefore, the address or content of the picture is recorded as a data transmission task, and the number of data transmission tasks is displayed as 1 on the upper right corner of the icon.

As shown in FIG. 5, a method for transmitting data provided in another embodiment includes the following steps:

501: Display an icon representative of a peer device as a first state when failing to connect the peer device.

502: Detect a data transmission event between the local device and the peer device.

This step may include: detecting whether an event of moving data onto the icon occurs on the local device; and, if so, determining that the local device initiates a data transmission event of transmitting the data to the peer device.

503: If the data transmission event is to transmit unopened data, record the address or content of the data.

504: When the local device is connected with the peer device successfully, transmit the recorded content of the data to the peer device, and display the icon as a second state; or, obtain the content of the data according to the recorded address of the data, transmit the obtained content of the data to the peer device, and display the icon as a second state. The procedure is ended.

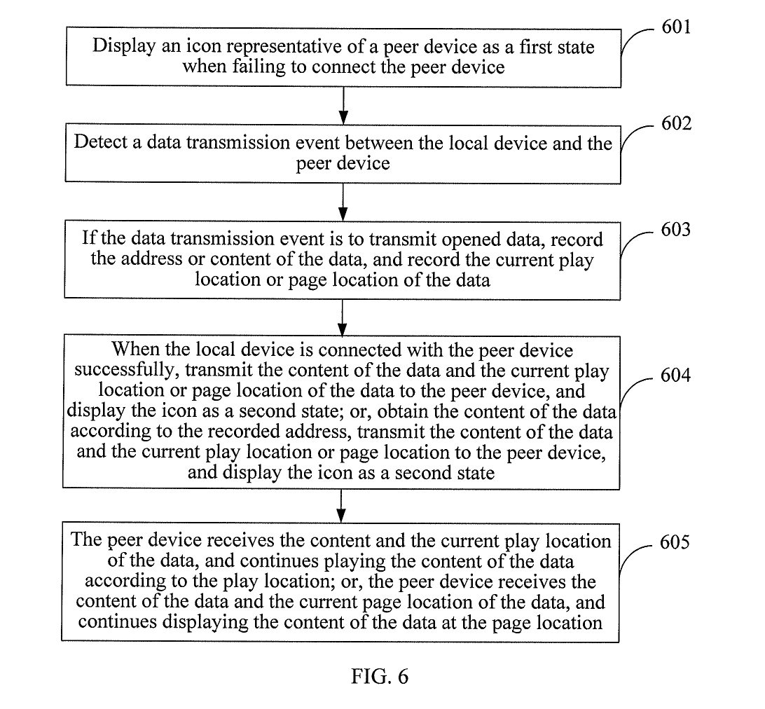

As shown in FIG. 6, a method for transmitting data provided in still another embodiment includes the following steps:

601: Display an icon representative of a peer device as a first state when failing to connect the peer device.

602: Detect a data transmission event between the local device and the peer device.

This step may include: detecting whether an event of moving data to the icon occurs on the local device; and, if so, determining that the local device initiates a data transmission event of transmitting the data to the peer device.

603: If the data transmission event is to transmit opened data, record the address or content of the data, and record the current play location or page location of the data.

604: When the local device is connected with the peer device successfully, transmit the recorded content of the data and the current play location or page location of the data to the peer device, and display the icon as a second state; or, obtain the content of the data according to the recorded address of the data, transmit the obtained content of the data and the recorded current play location or page location of the data to the peer device, and display the icon as a second state.

605: The peer device receives the content of the data and the current play location of the data, and continues playing the content of the data according to the play location; or, the peer device receives the content of the data and the current page location of the data, and continues displaying the content of the data at the page location. The procedure is ended.

In this embodiment, after receiving the content of the data and the play location, the peer device can continue playing the content of the data according to the play location of the data. In this way, the user can continue playing on the peer device, and have better experience. Specifically, the data may be a media file. The media file includes a music file or video file, which is not limited herein.

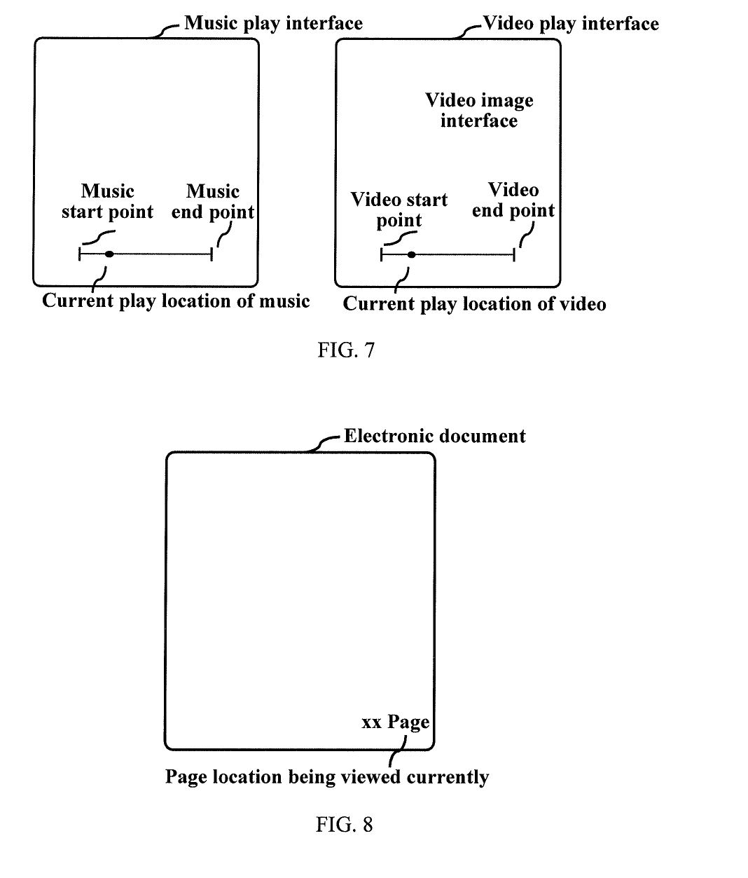

In this embodiment, the location information of the media file being played may be displayed on the screen so that the user understands the current play progress more intuitively. For example, as shown in FIG. 7, the left diagram is a play interface of a music file, and displays the start location of the music file, the end location of the music file, and the current play location of the music file; the right diagram is the play interface of the video file, the middle part is the screen of playing the video, and the lower part displays the start location of the video file, the end location of the video file, and the current play location of the video file. The current play location of the music file or the current play location of the video file is transmitted to the peer device so that the peer device can continue playing.

In this embodiment, after receiving the content of the data and the page location, the peer device can continue displaying the content of the data according to the page location of the data. In this way, the user can continue reading on the peer device, and have better experience. Specifically, the data may be an electronic document such as a doc file.

For example, as shown in FIG. 8, the user of the local device is reading an electronic document. The interface displays the content of the document, and the lower part displays the current page information. When the electronic document is transmitted to the peer device, the current page information is also transmitted to the peer device, and therefore, after the peer device receives the document, the user can continue reading the electronic document on the peer device, and have better experience.

Further, any method provided in the foregoing may include the following step:

receiving a request for viewing data transmission tasks of the user, and expanding a list of created data transmission tasks according to the request.

Specifically, the method may include: when the user presses and holds a displayed icon of the peer device, popping up a window in which a list of data transmission tasks is displayed. The list displays the information items of each piece of data to be transmitted. Generally, the information items are displayed in the form of a file name so that the user can view the information easily. The location of the window may be near the icon, such as, upper side, lower side, left side, or right side to the icon. The area occupied by the window in the screen may partly overlap the icon, or may be totally independent without overlapping the icon at all, which is not limited herein.

Besides, the default number of objects displayed in the window may be set. When the number of pieces of data to be transmitted exceeds the default number, the bottom part of the list displays “other”. By clicking the “other” location, the user can see more content. The default number of displayed objects is not limited herein.

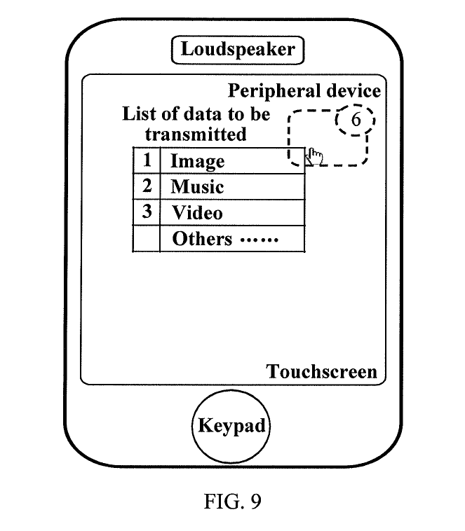

For example, as shown in FIG. 9, the display screen of the local device uses a dotted line boundary to display the icon of a peripheral device, indicating that the peripheral device is currently not connectible. The user of the local device drags 6 pieces of data onto the icon. Therefore, the number displayed on the upper right corner of the icon is 6, indicating that 6 pieces of data are to be transmitted. When the user presses and holds the icon, a window appears on the lower left side of the icon. A list of data to be transmitted is displayed in the window. The list includes information on the 6 pieces of data, such as file names. Further, the default number of objects displayed in the window may be set to 3, and therefore, other information is omitted and not displayed currently. By clicking the “other” location, the user can see information of other data to be transmitted.

Further, any method provided in the foregoing may include the following step:

executing multiple data transmission tasks consecutively in the order of the user requests when there are multiple data transmission tasks; or

executing multiple data transmission tasks consecutively in reverse order of the order of the user requests when there are multiple data transmission tasks; or

executing multiple data transmission tasks according to preset priority levels of the transmission tasks when there are multiple data transmission tasks.

For example, the data to be transmitted includes three files: an image file, a music file, and a Word file. The user of the local device drags the icons of the files to the icon of the peer device consecutively according to the order, and the local device records the order of the requests. Therefore, when the peer device is connectible, the local device can transmit the three files: the image file, the music file and the Word file consecutively according to the order of the requests. Or, on the local device, the order of transmitting the data is set as contrary to the request order. Therefore, the 3 files are transmitted in reverse order, namely, the transmission order is: the Word file, the music file, and the image file.

In the methods provided in the foregoing, the detecting the data transmission event between the local device and the peer device may include:

detecting a selection instruction input into the local device;

selecting a target file corresponding to the selection instruction on the local device according to the selection instruction;

detecting a movement trace input into the local device, where the movement trace is a trace of moving the target file; and

moving the target file along the detected movement trace, and when the target file is moved onto the icon representative of the peer device, determining that the local device initiates a data transmission event of transmitting the data to the peer device.

In the various methods provided in the embodiments, the data transmission event between the local device and the peer device is detected, the corresponding data transmission task is created, and the data transmission task is executed after the peer device is connected successfully. In this way, the unconnected device is operated, and the data is transmitted automatically after the device is connected successfully. The user does not have to wait for connecting, the interactive operations for data transmission in a complicated environment are simplified, the user is facilitated significantly, the user experience is enhanced, and the user is more interested in sharing and more attached to the product. At the time of transmitting a media file being played or an electronic document being read, the current play location of the media file or the current page location of the electronic document are transmitted, and therefore, the peer device can continue playing or continue displaying upon receiving the data, thereby greatly facilitating the user to continue playing or reading, avoiding the trouble of searching according to memorization of the user, and bringing better experience.

It should be noted that in the embodiments, the user of the local device may also transmit data synchronously when the peer device is in the connected state. When the user drags the data onto the icon of the peer device for transmitting, the local device transmits the data onto the peer device synchronously and automatically. If the receiving speed of the peer device is slow and the user drags a large amount of data, the number of pieces of the data to be transmitted may be displayed in real time in the way described in the embodiment shown in FIG. 3 in the transmission process.

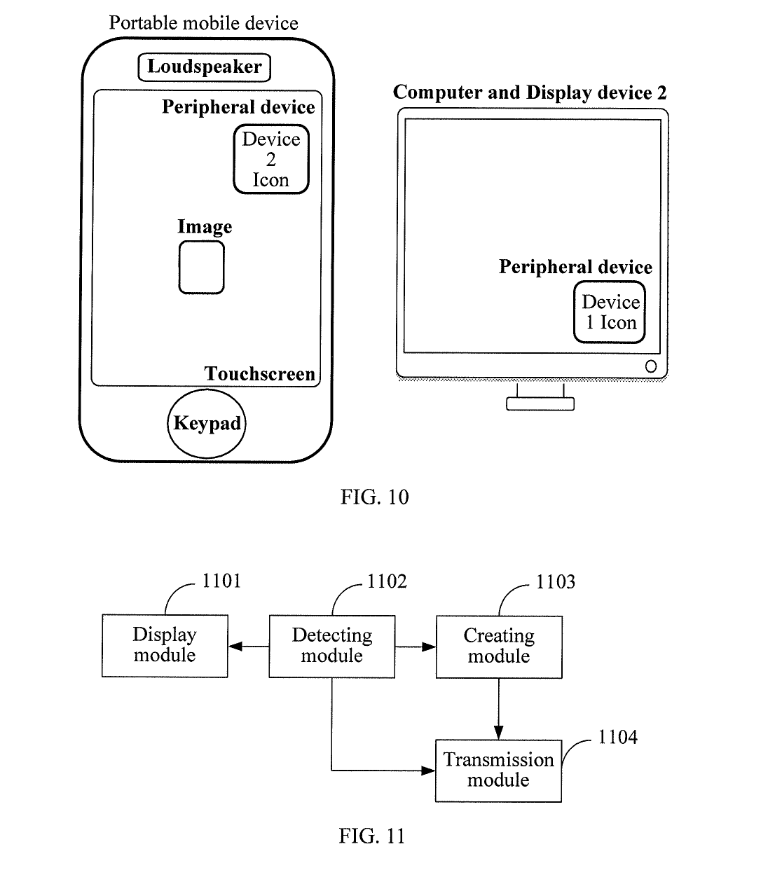

In this embodiment, the screen of the peer device may display in various ways described in the foregoing. For example, as shown in FIG. 10, the local device is a portable mobile device 1, such as mobile phone, and the peer device is a computer with a display device 2, such as a desktop computer. The icon of the device 2 is displayed on device 1, and the icon of device 1 is displayed on the screen of the device 2. The icons are displayed through a dotted line boundary when the connection between the two devices fails, and are displayed through a solid line boundary when the connection between the two devices succeeds, which facilitates the user to check the connection state.

As shown in FIG. 11, an apparatus for transmitting data provided in yet another embodiment includes:

a display module 1101, configured to display an icon representative of a peer device as a first state when failing to connect the peer device, and display the icon as a second state when the apparatus is connected with the peer device successfully;

a detecting module 1102, configured to detect a data transmission event between the apparatus and the peer device;

a creating module 1103, configured to create a data transmission task corresponding to the data transmission event detected by the detecting module 1102; and

a transmission module 1104, configured to execute the data transmission task created by the creating module 1103 when the apparatus is connected with the peer device successfully.

In this embodiment, the detecting module 1102 is specifically configured to detect multiple data transmission events between the apparatus and the peer device. Correspondingly, the creating module 1103 is specifically configured to create data transmission tasks corresponding to the multiple data transmission events detected by the detecting module 1102. On that basis, the display module 1101 is further configured to: display the number of data transmission tasks created by the creating module 1103 on the periphery of the icon; or further configured to: receive a request for viewing the data transmission tasks of the user, and expand a list of the data transmission tasks according to the request.

In this embodiment, when the display module 1101 displays the number of data transmission tasks on the periphery of the icon, the display module 1101 is further configured to: decrease the number of displayed data transmission tasks accordingly once the transmission module 1104 finishes a data transmission task.

In this embodiment, the detecting module 1102 is specifically configured to: detect whether an event of dragging data to the icon occurs on the apparatus; and, if so, determine that the apparatus initiates a data transmission event of transmitting the data to the peer device.

In this embodiment, the creating module 1103 includes:

a first creating unit, configured to: if the data transmission event is to transmit unopened data, record the address or content of the data as a data transmission task; or

a second creating unit, configured to: if the data transmission event is to transmit opened data, record the address or content of the data, record the current play location or page location of the data, and use all recorded contents as a data transmission task.

In the apparatus provided in any embodiment, the transmission module 1104 is configured to: execute multiple data transmission tasks consecutively in the order of the user requests or in reverse order when there are multiple data transmission tasks.

The apparatus provided herein can implement the method provided in any embodiment above. Details may be obtained with reference to the descriptions of the method embodiments, and are not repeated herein. The apparatus is located in the local device, and the local device may be connected with the peer device in a wired mode or wireless mode.

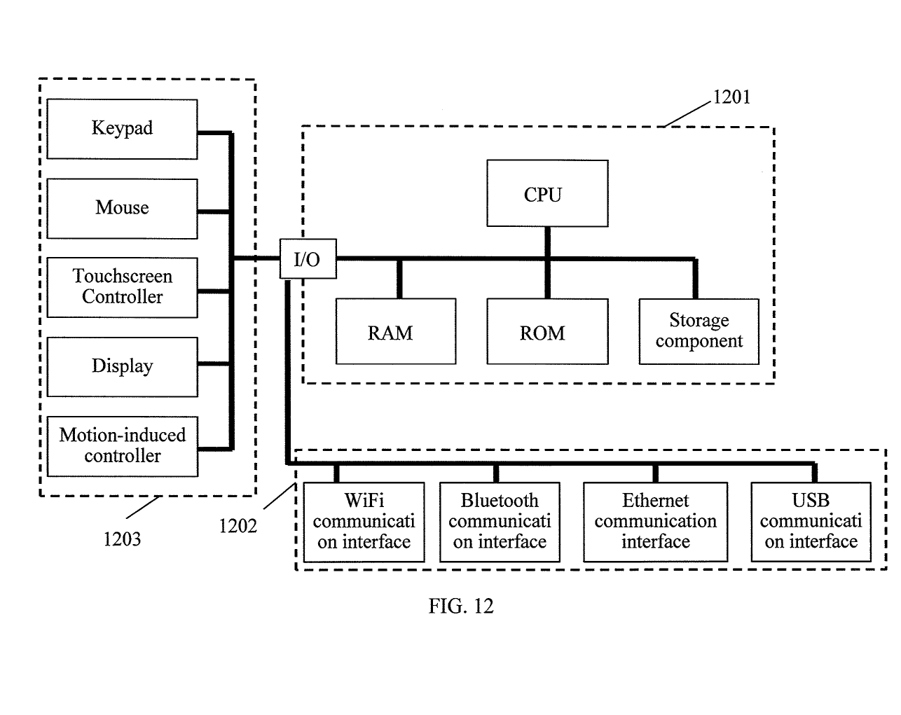

As shown in FIG. 12, in this embodiment, the local device may include: a controller and storage 1201, a communication interface 1202, and a peripheral device 1203. Specifically, the controller and storage 1201 includes: a CPU (Central Process Unit, central processing unit), a RAM (Random Access Memory, random access memory), a ROM (Read-Only Memory, read-only memory), and a storage device. The types of the communication interface include but are not limited to at least one of the following types: WiFi communication interface, Bluetooth communication interface, Ethernet communication interface, and USB (Universal Serial Bus, universal serial bus) communication interface. The types of the peripheral device 1203 include but are not limited to at least one of the following types: keyboard, mouse, touch controller, display, and motion-induced controller. The CPU, the RAM, the ROM, and the storage device are interconnected through an internal bus. The controller and storage 1201 is connected with the peripheral device 1203 and the communication interface 1202 through an I/O (input/output) port.

Through the apparatus provided in this embodiment, the data transmission event between the apparatus and the peer device is detected, the corresponding data transmission task is created, and the data transmission task is executed after the peer device is connected successfully. In this way, the unconnected device is operated, and the data is transmitted automatically after the device is connected successfully. The user does not have to wait for connecting, the interactive operations for data transmission in a complicated environment are simplified, the user is facilitated significantly, the user experience is enhanced, and the user is more interested in sharing and more attached to the product. At the time of transmitting a media file being played or an electronic document being read, the current play location of the media file or the current page location of the electronic document are transmitted, and therefore, the peer device can continue playing or continue displaying upon receiving the data, thereby greatly facilitating the user to continue playing or reading, avoiding the trouble of searching according to memorization of the user, and bringing better experience.

Persons of ordinary skill in the art should understand that all or a part of the steps of the foregoing embodiments may be implemented through hardware, or may be implemented by a program instructing relevant hardware. The program may be stored in a computer readable storage medium. The storage medium may be a read-only memory, a magnetic disk, or an optical disk.

The above descriptions are merely preferred embodiments, but are not intended to limit the scope of the claims. Modifications, equivalent replacements, or improvements may be made to the embodiments. Such modified embodiments are understood to fall within the scope of the.

What is claimed is:

1. A method for transmitting data, comprising:
displaying an icon representative of a peer device in a first state when failing to connect the peer device;
detecting a data transmission event between a local device and the peer device;
creating a data transmission task corresponding to the detected data transmission event; and
when the local device is connected with the peer device successfully, executing the data transmission task, and displaying the icon representative of the peer device in a second state.

2. The method according to claim 1, wherein:
the detecting the data transmission event between the local device and the peer device comprises: detecting multiple data transmission events between the local event and the peer device; and
the creating of the data transmission task corresponding to the detected data transmission event comprises: creating data transmission tasks corresponding to the multiple detected data transmission events.

3. The method according to claim 2, further comprising:
displaying a number of data transmission tasks on a periphery of the icon.

4. The method according to claim 2, further comprising:
receiving a request for viewing the data transmission tasks of a user, and expanding a list of created data transmission tasks according to the request.

5. The method according to claim 3, further comprising:
once a data transmission task is complete, decreasing the number of data transmission tasks displayed on the periphery of the icon accordingly.

6. The method according to claim 1, wherein:
the detecting of the data transmission event between the local device and the peer device comprises:
detecting a selection instruction input into the local device;
selecting a target file corresponding to the selection instruction on the local device according to the selection instruction;
detecting a movement trace input into the local device, wherein the movement trace is a trace of moving the target file; and
moving the target file along the detected movement trace, and
when the target file is moved onto the icon representative of the peer device, determining that the local device initiates a data transmission event of transmitting the data to the peer device.

7. The method according to claim 1, wherein:
the detecting of the data transmission event between the local device and the peer device comprises:
determining whether an event associated with movement of data to the icon occurs on the local device; and,
if movement occurs, determining that the local device has initiated a data transmission event that indicates transmission of the data to the peer device.

8. The method according to claim 1, wherein:
creating of the data transmission task corresponding to the detected data transmission event comprises:
if the data transmission event is associated with transmission unopened data, recording an address or content of the data as a data transmission task; or
if the data transmission event is associated with transmission of opened data, recording the address or content of the data, recording current play location or page location of the data, and using all recorded content as a data transmission task.

9. The method according to claim 1, wherein execution of the data transmission task comprises:
executing multiple data transmission tasks consecutively in order of user requests when there are multiple data transmission tasks; or
executing multiple data transmission tasks consecutively in reverse order of the order of the user requests when there are multiple data transmission tasks; or
executing multiple data transmission tasks according to preset priority levels of the transmission tasks when there are multiple data transmission tasks.

10. An apparatus for transmitting data, comprising:
a display module configured to display an icon representative of a peer device in a first state when failing to connect the peer device, and display the icon in a second state when the apparatus is connected with the peer device successfully;
a detecting module configured to detect a data transmission event between the apparatus and the peer device;
a creating module configured to create a data transmission task corresponding to the data transmission event detected by the detecting module; and
a transmission module configured to execute the data transmission task created by the creating module when the apparatus is connected with the peer device successfully.

11. The apparatus according to claim 10, wherein:
the detecting module is configured to detect multiple data transmission events between the apparatus and the peer device; and
the creating module is configured to create data transmission tasks corresponding to the multiple data transmission events detected by the detecting module.

12. The apparatus according to claim 11, wherein the display module is further configured to display a number of data transmission tasks created by the creating module on periphery of the icon.

13. The apparatus according to claim 11, wherein the display module is further configured to receive a request for viewing the data transmission tasks of a user, and expand a list of the data transmission tasks according to the request.

14. The apparatus according to claim 12, wherein the display module is further configured to decrease the number of displayed data transmission tasks once the transmission module finishes a data transmission task.

15. The apparatus according to claim 10, wherein the detecting module is configured to:
detect a selection instruction input into the local device;
select a target file corresponding to the selection instruction on the local device according to the selection instruction;
detect a movement trace input into the local device, wherein the movement trace is a trace of moving the target file;
move the target file along the detected movement trace; and
when the target file is moved onto the icon representative of the peer device, determine that the local device initiates a data transmission event of transmitting the data to the peer device.

16. The apparatus according to claim 10, wherein the detecting module is configured to detect whether an event associated with movement of data to the icon occurs on the apparatus; and, if so, determine that the apparatus has initiated a data transmission event of transmitting the data to the peer device.

17. The apparatus according to claim 10, wherein the creating module comprises:
a first creating unit configured to: record an address or content of the data as a data transmission task if the data transmission event is to transmit unopened data; or
a second creating unit configured to: record the address or content of the data, record current play location or page location of the data, and use all recorded contents as a data transmission task when the data transmission event is to transmit opened data.

18. The apparatus according to claim 10, wherein the transmission module is configured to:
execute multiple data transmission tasks consecutively in order of user requests when there are multiple data transmission tasks; or
execute multiple data transmission tasks consecutively in reverse order of the order of the user requests when there are multiple data transmission tasks; or
execute multiple data transmission tasks according to preset priority levels of the transmission tasks when there are multiple data transmission tasks.
